(19) United States
(12) Patent Application Publication
(10) Pub. No.: US 2026/0092650 A1
(43) Pub. Date: Apr. 2, 2026

(54) COMPLIANT PISTON PNEUMATIC VALVE ACTUATOR

(71) Applicant: ASM IP Holding B.V., Almere (NL)

(72) Inventor: Hannelore Azora Hemminger, Tempe, AZ (US)

(21) Appl. No.: 19/338,100

(22) Filed: Sep. 24, 2025

Related U.S. Application Data
(60) Provisional application No. 63/700,496, filed on Sep. 27, 2024.

(51) Int. Cl. F16K 7/17; F16K 31/122

(52) U.S. Cl. CPC F16K 7/17; F16K 31/122

(57) ABSTRACT

A diaphragm valve is provided. The valve body includes a valve channel including an inlet channel and an outlet channel. The diaphragm valve further includes a valve seat adjacent to the valve channel. The valve also includes a diaphragm movable to separate from or contact with the valve seat. Further, the valve includes a piston coupled to the diaphragm and a flexure assembly coupled to the piston. An input force maybe applied to the piston in a first direction to output a resultant force such that when the diaphragm is in a normally closed position, the resultant force moves the diaphragm to an open position, and when the diaphragm is in a normally open position, the resultant force moves the diaphragm to a closed position. In some examples, the resultant force may be output in a second direction that may be opposite or perpendicular to the input force.

### CROSS-REFERENCE TO RELATED APPLICATIONS

This application is a nonprovisional of, and claims priority to and the benefit of, U.S. Provisional Patent Application No. 63/700,496, filed Sep. 27, 2024 and entitled “COMPLIANT PISTON PNEUMATIC VALVE ACTUATOR,” which is hereby incorporated by reference herein.

### FIELD OF INVENTION

The present disclosure relates generally to a diaphragm valve and in particular, a diaphragm valve comprising a valve component including an annular flexure.

### BACKGROUND OF THE DISCLOSURE

Semiconductor processing apparatuses commonly use one or more reactants, i.e., precursors, as source chemicals for performing substrate processes, such as, for example, deposition, cleaning, and etching processes. Such semiconductor processing apparatuses frequently comprise a reaction chamber into which the precursors are supplied in order to perform the desired process. The supply of the precursor to the reaction chamber may be performed by a precursor delivery system and such precursor delivery systems may utilize one or more valves to control the flow of precursor to the reaction chamber.

A precursor delivery system may utilize one or more diaphragm valves positioned in a flow path between a source vessel of the precursor and the reaction chamber to enable flow control of the precursor into the reaction chamber. Precursors, such as vapor phase precursors, may be pulsed into a reaction chamber by the opening and closing of an appropriate diaphragm valve in the precursor delivery system. Diaphragm valves may comprise an actuator configured for opening and closing a flexible diaphragm against a valve seat. When the diaphragm valve is in the open position, the precursor is allowed to pass through a valve channel and enter the reaction chamber. When the diaphragm valve is in the closed position, the diaphragm obstructs the valve channel and prevents the precursor from entering the reaction chamber.

An example of a semiconductor processing apparatus that may utilize a precursor delivery system comprising one or more diaphragm valves is an atomic layer deposition (ALD) apparatus. ALD is a method of depositing thin films on a substrate comprising sequential and alternating self-saturating surface reactions wherein one or more vapor phase precursors may be pulsed into the ALD reaction chamber to enable film deposition. ALD processes may require precise temperature control of the precursors, not only in the reaction chamber, but also in the precursor delivery system utilized to provide the precursor to the reaction chamber. In particular precise temperature of the wetted surfaces of the precursor delivery system, i.e., those surfaces in direct contact with the precursor, may be desired for optimal film deposition and apparatus lifetime.

Fast-pulsing valves are critical to atomic layer deposition due to the large number of pulses used in the processes. However, current fast pulsing valves cannot be packed in a tight space due to proximity of valves to each other. Further, conventionally available pneumatic fast pulsing valves are limited in their speed and temperature capability due to the tight sliding piston joint causing friction and binding due to thermal expansion. Also, any thermal expansion may result in asymmetric expansion.

Accordingly, there is a need in the art for improved diaphragm valve that does not include sliding or rotating joints and surfaces that cause friction, while also maintaining good symmetry to minimize parasitic motions resulting from any thermal expansion.

### SUMMARY OF THE DISCLOSURE

This summary is provided to introduce a selection of concepts in a simplified form. These concepts are described in further detail in the detailed description of example embodiments of the disclosure below. This summary is not intended to identify key features or essential features of the claimed subject matter, nor is it intended to be used to limit the scope of the claimed subject matter.

A valve is provided. Specifically, in some examples, a diaphragm valve is provided. The valve body includes a valve channel including an inlet channel and an outlet channel. The valve further includes a valve seat adjacent to the valve channel. The valve also includes a diaphragm movable to contact the valve seat. Further, the valve includes a piston coupled to the diaphragm and an annular flexure coupled to the piston.

A method of operating a diaphragm valve is provided. The method includes coupling an annular flexure to a piston of the diaphragm valve. The method further includes coupling the piston with a diaphragm. The method also includes applying an input force to the piston in a first direction to output a resultant force such that when the diaphragm is in a normally closed position, the resultant force moves the diaphragm to an open position, and when the diaphragm is in a normally open position, the resultant force moves the diaphragm to a closed position.

An actuator is provided. The actuator includes a diaphragm movable to separate from or contact with the valve seat. The actuator also includes a piston coupled to the diaphragm. The actuator further includes a flexure assembly coupled to the piston such that the diaphragm is actuated by applying force on the flexure assembly.

All of these embodiments are intended to be within the scope of the invention herein disclosed. These and other embodiments will become readily apparent to those skilled in the art from the following detailed description of certain embodiments having reference to the attached figures, the invention not being limited to any particular embodiment(s) disclosed.

### BRIEF DESCRIPTION OF THE DRAWING FIGURES

While the specification concludes with claims particularly pointing out and distinctly claiming what are regarded as embodiments of the invention, the advantages of embodiments of the disclosure may be more readily ascertained from the description of certain examples of the embodiments of the disclosure when read in conjunction with the accompanying drawings, in which:

FIGS. 1A-1B illustrates a cross-sectional view of one exemplary diaphragm valve in accordance with some examples of this technology;

FIG. 2 illustrate a cross-sectional view of another exemplary diaphragm valve in accordance with some examples of this technology;

FIG. 3 illustrate a cross-sectional view of yet another exemplary diaphragm valve in accordance with some examples of this technology;

FIG. 4 illustrate a cross-sectional view of a symmetric flexure assembly such as the one in FIGS. 2 and 3 in accordance with some examples of this technology;

FIG. 5 illustrates a flow diagram of a method for operating a diaphragm valve of FIGS. 1-3 in accordance with some examples of this technology.

It will be appreciated that elements in the figures are illustrated for simplicity and clarity and have not necessarily been drawn to scale. For example, the relative size of some of the elements in the figures may be exaggerated relative to other elements to help improve understanding of illustrated embodiments of the present disclosure.

### DETAILED DESCRIPTION OF EXEMPLARY EMBODIMENTS

Although certain embodiments and examples are disclosed below, it will be understood by those in the art that the invention extends beyond the specifically disclosed embodiments and/or uses of the invention and obvious modifications and equivalents thereof. Thus, it is intended that the scope of the invention disclosed should not be limited by the particular disclosed embodiments described below.

The illustrations presented herein are not meant to be actual views of any particular material, apparatus, structure, or device, but are merely idealized representations that are used to describe embodiments of the disclosure.

As used herein, the term “substrate” may refer to any underlying material or materials that may be used, or upon which, a device, a circuit or a film may be formed.

As used herein, the term “atomic layer deposition” (ALD) may refer to a vapor deposition process in which deposition cycles, preferably a plurality of consecutive deposition cycles, are conducted in a process chamber. Typically, during each cycle the precursor is chemisorbed to a deposition surface (e.g., a substrate surface or a previously deposited underlying surface such as material from a previous ALD cycle), forming a monolayer or sub-monolayer that does not readily react with additional precursor (i.e., a self-limiting reaction). Thereafter, if necessary, a reactant (e.g., another precursor or reaction gas) may subsequently be introduced into the process chamber for use in converting the chemisorbed precursor to the desired material on the deposition surface. Typically, this reactant is capable of further reaction with the precursor. Further, purging steps may also be utilized during each cycle to remove excess precursor from the process chamber and/or remove excess reactant and/or reaction byproducts from the process chamber after conversion of the chemisorbed precursor. Further, the term “atomic layer deposition,” as used herein, is also meant to include processes designated by related terms, such as “chemical vapor atomic layer deposition,” “atomic layer epitaxy” (ALE), molecular beam epitaxy (MBE), gas source MBE, or organometallic MBE, and chemical beam epitaxy when performed with alternating pulses of precursor composition(s), reactive gas, and purge (e.g., inert carrier) gas.

As used herein, the term “chemical vapor deposition” may refer to any process wherein a substrate is exposed to one or more volatile precursors, which react and/or decompose on a substrate surface to produce a desired deposition.

As used herein, the term “wetted surface” may refer to surface of a valve which may come into direct contact with a chemical precursor.

As used herein, the term “non-wetted surface” may refer to a surface of a valve which may not come into direct contact with a chemical precursor.

In the specification, it will be understood that the term “on” or “over” may be used to describe a relative location relationship. Another element or layer may be directly on the mentioned layer, or another layer (an intermediate layer) or element may be intervened therebetween, or a layer may be disposed on a mentioned layer but not completely cover a surface of the mentioned layer. Therefore, unless the term “directly” is separately used, the term “on” or “over” will be construed to be a relative concept. Similarly to this, it will be understood the term “under,” “underlying,” or “below” will be construed to be relative concepts.

The embodiments of the disclosure may include valves, valve components, and related methods for forming valve components. The valves may further include diaphragm valves, bellows valves or any other valve capable of incorporating the embodiments described in the disclosure. In particular, the embodiments of the disclosure provide a diaphragm valve which may incorporate a flexible heater disposed over the non-wetted surface of the diaphragm, the flexible heater allowing for the precise temperature control over the wetted surface of the diaphragm. For example, the diaphragm valve of the current disclosure may be utilized as a component part of a precursor delivery system employed to deliver one or more precursors to the reaction chamber of a deposition apparatus, such as, for example, an ALD apparatus, whereby the diaphragm valve of the current disclosure may result in film deposition with reduced defectivity. Furthermore, the diaphragm valve of the current disclosure may increase the operational lifetime (i.e., “up time”) of a semiconductor processing apparatus as well reducing the time period between maintenance cycles.

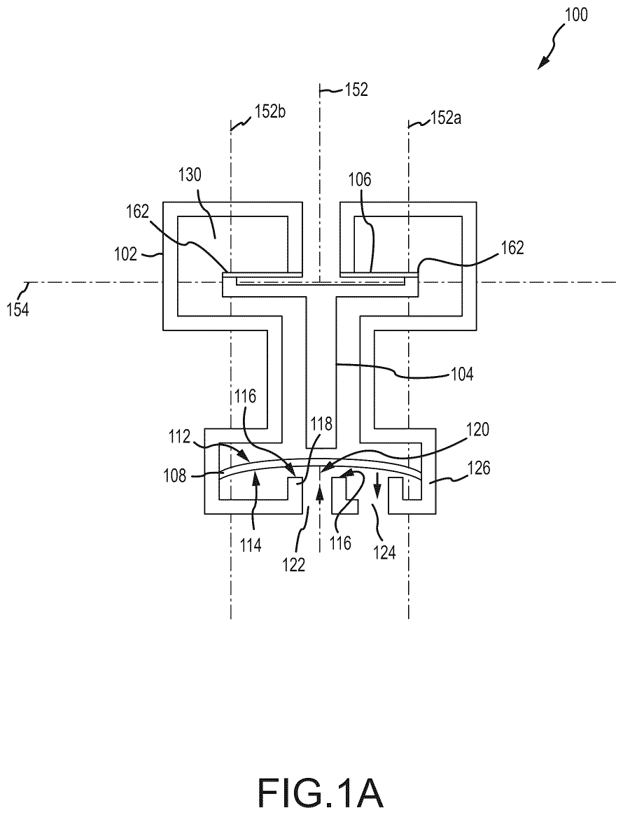

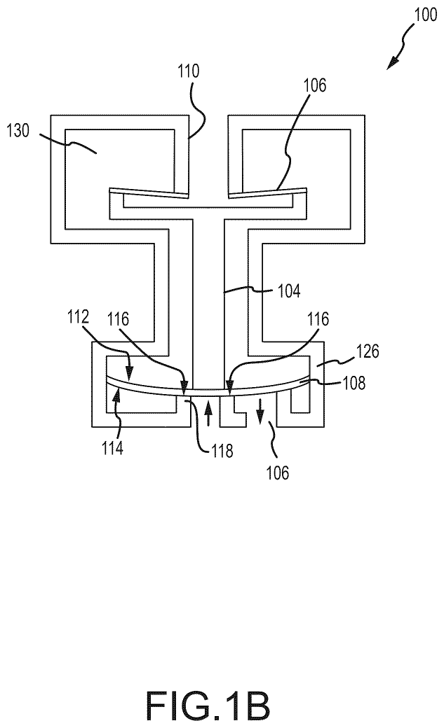

FIG. 1 illustrates a cross-sectional schematic diagram of an exemplary diaphragm valve 100 in accordance with the embodiments of the disclosure. It should be noted that the diaphragm valve 100 of FIG. 1 is a non-limiting example configuration for a valve incorporating a valve component comprising a flexible heater. Alternative configurations of a valve may be envisioned that may incorporate the flexible heater of the current disclosure. It should also be noted that FIG. 1 illustrates simplified cross-sectional diagram of an exemplary valve demonstrating the key features of the valve needed for understanding the embodiments of the disclosure.

In more detail, FIG. 1A illustrates a cross-sectional illustration of an exemplary diaphragm valve 100 in open position, i.e., a valve channel 120 disposed between an inlet channel 122 and outlet channel 124 is unobstructed by a flexible diaphragm 108, thereby allowing precursor to flow freely through the diaphragm valve 100. FIG. 1B illustrates a cross-sectional illustration of an exemplary diaphragm valve 100 in closed position, i.e., the valve channel 120 disposed between an inlet channel 122 and outlet channel 124 is obstructed by the flexible diaphragm 108, thereby preventing a precursor from flowing through the diaphragm valve 100.

In more detail, the valve body 102 may comprise a valve channel 120 including an inlet channel 122 and an outlet channel 124. The inlet channel 122 may be fluidly connected to a source vessel (not illustrated) containing a suitable precursor. For example, the source vessel may contain a precursor in a solid phase, a liquid phase, a vapor phase, or mixtures thereof. In embodiments wherein the precursor is in the solid or liquid phase, the source vessel may also include means for converting the precursor to a vapor phase precursor, such as, for example, one or more heaters. The outlet channel 124 may be fluidly connected to a reaction chamber of a semiconductor processing apparatus. For example, the reaction chamber may be utilized for one or more deposition processes, etching process, and/or cleaning processes. In particular embodiments of the disclosure, the outlet channel 124 may be fluidly connected to a reaction chamber of a semiconductor deposition apparatus, such as, for example, an atomic layer deposition (ALD) apparatus or a chemical vapor deposition (CVD) apparatus.

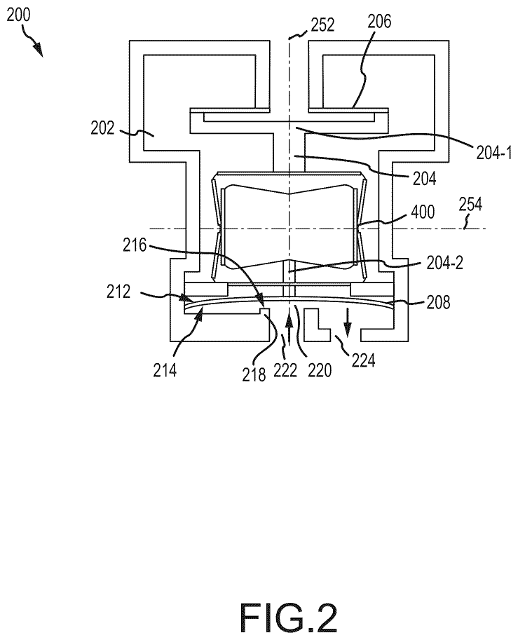

A valve seat 118 may be disposed adjacent to the valve channel 120 and may surround the upper portion of the inlet channel 122. The valve seat 118 includes an upper surface 116 that presents a sealing surface against which a wetted surface 114 of the flexible diaphragm 108 is pressed against in order to close the valve channel 120. The upper surface 116 of the valve seat 118 may be polished or otherwise made smooth to reduce contact resistance and to reduce leakage of precursor between the valve seat 118 and the flexible diaphragm 108 when the flexible diaphragm 108 is in the closed positioned, as illustrated in FIG. 2. Although the upper surface 116 of the valve seat 118 is illustrated as a planar surface in FIGS. 1A and 1B, alternative sealing surfaces for the upper surface 116 may be utilized. For example, upper surface 116 of the valve seat 118 may include a seating ridge (not shown) that extends upwardly from the upper surface 116 towards the flexible diaphragm 108, wherein the seating ridge may be sufficiently prominent and sized to deform the wetted surface of the flexible diaphragm 108 when the flexible diaphragm 108 is pressed against the valve seat 118.

The flexible diaphragm 108 may comprise a wetted surface 114, i.e., a surface which may come into direct contact with a precursor flowing through the diaphragm valve 100, and a non-wetted surface 112, i.e., a surface that may not come into direct contact with a precursor flowing through the diaphragm valve 100. The flexible diaphragm 108 may be disposed adjacent to the valve channel 120 and may be secured to the valve body 102 at a rim 126. The valve further comprises a flexible heater, where the flexible heater may be disposed over the non-wetted surface 112 of the flexible diaphragm 108.

The diaphragm valve 100 further comprises an actuator that may be operable to move a surface of the flexible diaphragm 108 into and out of contact with the valve seat to thereby open and close the valve channel 120. In more detail, the actuator may be coupled to a blade flexure 106. Blade flexure 106 is further coupled to a piston 104 that contacts the upper surface of flexible diaphragm 108. The actuator may include a number of actuating mechanisms including, but not limited to, pneumatic, hydraulic, and piezoelectric mechanisms.

Blade flexure 106 is designed to flex in direction of axis 152. Further, blade flexure 106 is fixed to piston 104 at end 162 and stays unfixed at the other end. Accordingly, when subject to external force perpendicular to its length, blade flexure 106 undergoes deformation, permitting rotational movement about intersection point of axes 152a, 152b and 154.

In operation, air supply is injected internally into the cylinder holding diaphragm valve 100. Accordingly, the internal pressure is increased within the internal space 130 of diaphragm valve 100. When piston 104 is pressurized, it seeks to become closer to a sphere and results in flexing of the blade flexure 106, allowing a translational degree of freedom by lengthening. Thus, piston 104 is actuated due to the internal pressure and compresses flexible diaphragm 108, actuating diaphragm valve 100 (see FIG. 1B). When the pressure is released, flexible diaphragm 108 is decompressed and diaphragm valve 100 is opened.

FIG. 2 illustrates a cross-sectional schematic diagram of another exemplary diaphragm valve 200 in accordance with the embodiments of the disclosure. In FIG. 2, diaphragm valve 200 is shown in open position, i.e., a valve channel 220 disposed between an inlet channel 222 (functioning similarly to inlet channel 122) and outlet channel 224 (functioning similarly to outlet channel 124) is unobstructed by a flexible diaphragm 208 (functioning similarly to flexible diaphragm 108), thereby allowing precursor to flow freely through the diaphragm valve 200.

Similar to diaphragm valve 100 of FIG. 1, a valve seat 218 may be disposed adjacent to the valve channel 220 and may surround the upper portion of the inlet channel 222. The valve seat 218 includes an upper surface 216 (functioning similarly to upper surface 116) that presents a sealing surface against which a wetted surface 214 of the flexible diaphragm 208 is pressed against in order to close the valve channel 220. The upper surface 216 of the valve seat 218 may be polished or otherwise made smooth to reduce contact resistance and to reduce leakage of precursor between the valve seat 218 and the flexible diaphragm 108 when the flexible diaphragm 108 is in the closed positioned.

The flexible diaphragm 208 may comprise a wetted surface 214 (functioning similarly to wetted surface 114 of FIG. 1), i.e., a surface which may come into direct contact with a precursor flowing through the diaphragm valve 200, and a non-wetted surface 212 (functioning similarly to non-wetted surface 112), i.e., a surface that may not come into direct contact with a precursor flowing through the diaphragm valve 200. In exemplary embodiments, diaphragm valve 200 may be actuated using a blade flexure 206 (functioning similarly to blade flexure 106). In exemplary embodiments, diaphragm valve 200 may be actuated via actuator (functioning similarly to actuator of FIG. 1) that may include a number of mechanisms including, but not limited to, pneumatic, hydraulic, and piezoelectric mechanisms.

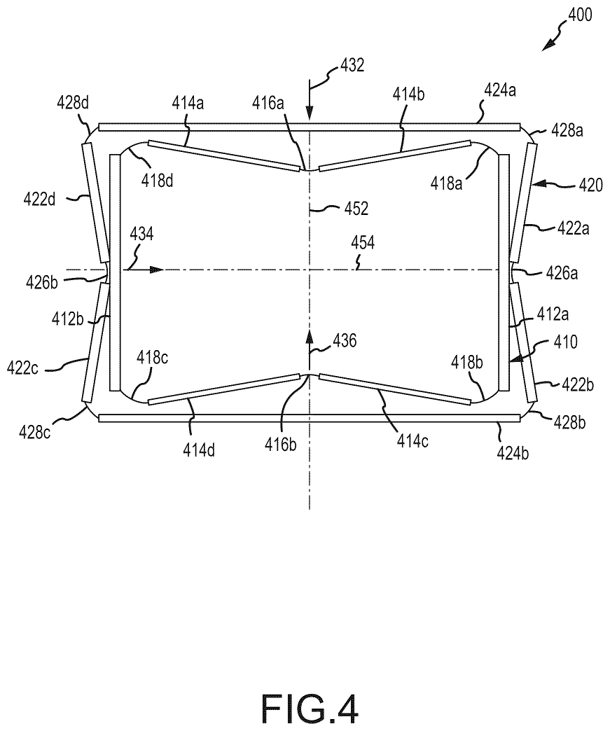

Further, diaphragm valve 200 includes a symmetric flexure assembly 400. Symmetric flexure assembly 400 is described in further detail FIG. 4. Symmetric flexure assembly 400 includes a first flexure section 410 and second flexure section 420. As shown in FIG. 4, in exemplary embodiments, first flexure section 410 is nested within second flexure section 420. In exemplary embodiments, first flexure section 410 and second flexure section 420 are two separate sections. Both first flexure section 410 and second flexure section 420 include thin segments and thick segments.

First flexure section 410 includes flexure one thick longer segments 412a and 412b. Flexure one thick longer segments 412a and 412b are parallel to axis 452. First flexure section 410 also includes flexure one thick shorter segments 414a, 414b, 414c and 414d. Further, first flexure section 410 includes flexure one thin corner segments 418a, 418b, 418c and 418d. First flexure section 410 also includes flexure one thin connecting segments 416a and 416b.

In exemplary embodiments, flexure one thick longer segments 412a and 412b are thicker than flexure one thick shorter segments 414a, 414b, 414c and 414d. Further, in exemplary embodiments, flexure one thin corner segments 418a, 418b, 418c and 418d are non-linear (i.e., curved). In exemplary embodiments, flexure one thin connecting segments 416a and 416b are non-linear (i.e., curved). In exemplary embodiments, flexure one thick shorter segments 414a, 414b, 414c and 414d are angled inwards to form an acute angle with flexure one thick longer segments 412a and 412b. Further, flexure one thick shorter segments 414a and 414b form an obtuse angle and flexure one thick shorter segments 414c and 414d form an obtuse angle.

As shown in FIG. 4, flexure one thick longer segment 412a is connected to flexure one thin corner segment 418a. Flexure one thin corner segment 418a is connected to flexure one thick shorter segment 414b. Flexure one thick shorter segment 414b is connected to flexure one thin connecting segment 416a. Flexure one thin connecting segment 416a is connected to flexure one thick shorter segment 414a. Flexure one thick shorter segment 414a is connected to flexure thin corner segment 418d. Flexure one thin corner segment 418d is connected to flexure one thick longer segment 412b. Flexure one thick longer segment 412b is connected to flexure one thin corner segment 418c. Flexure one thin corner segment 418c is connected to flexure one thick shorter segment 414d. Flexure one thick shorter segment 414d is connected to flexure one thin connecting segment 416b. Flexure one thin connecting segment 416b is connected to flexure one thick shorter segment 414c. Flexure one thick shorter segment 414c is connected to flexure one thin corner segment 418b. Flexure one thin corner segment 418b is connected to flexure one thick longer segment 412a.

In exemplary embodiments, flexure one thin connecting segments 416a and 416b include a thicker portion as well. That is, flexure one thin connecting segment 416a may include a first thin portion coupled to flexure one thick shorter segment 414a. Flexure one thick shorter segment 414a is further coupled to a thicker connecting portion, wherein the thicker connecting portion is further connected to a second thin portion which is connected to flexure one thick shorter segment 414b. Similarly, flexure one thin connecting segment 416b may include a third thin portion coupled to flexure one thick shorter segment 414c Flexure one thick shorter segment 414c is further coupled to a thicker connecting portion, wherein the thicker connecting portion is further connected to a fourth thin portion which is connected to flexure one thick shorter segment 414d. Such a design makes first flexure section 410 more robust so that when pressure is applied to first flexure section 410, flexure one thin connecting segments 416a or 416b have capability of handling increased force.

Second flexure section 420 includes flexure two thick longer segments 424a and 424b. Flexure two thick longer segments 424a and 424b are parallel to axis 454. Second flexure section 420 also includes flexure two thick shorter segments 422a, 422b, 422c and 422d. Further, second flexure section 420 includes flexure two thin corner segments 428a, 428b, 428c and 428d. Second flexure section 420 also includes flexure two thin connecting segments 426a and 426b.

In exemplary embodiments, flexure two thin corner segments 428a, 428b, 428c and 428d are non-linear (i.e., curved). In exemplary embodiments, flexure two thin connecting segments 426a and 426b are non-linear (i.e., curved). In exemplary embodiments, flexure two thick shorter segments 422a, 422b, 422c and 422d are angled inwards to form an acute angle with flexure two thick longer segments 424a and 424b. Further, flexure two thick shorter segments 422a and 422b form an obtuse angle and flexure two thick shorter segments 422c and 422d form an obtuse angle.

As shown in FIG. 4, flexure two thick longer segment 424a is connected to flexure two thin corner segment 428a. Flexure two thin corner segment 428a is connected to flexure two thick shorter segment 422a. Flexure two thick shorter segment 422a is connected to flexure two thin connecting segment 426a. Flexure two thin connecting segment 426a is connected to flexure two thick shorter segment 422b. Flexure two thick shorter segment 422b is connected to flexure two thin corner segment 428b. Flexure two thin corner segment 428b is connected to flexure two thick longer segment 424b. Flexure two thick longer segment 424b is connected to flexure two thin corner segment 428c. Flexure two thin corner segment 428c is connected to flexure tow thick shorter segment 422c. Flexure two thick shorter segment 422c is connected to flexure two thin connecting segment 426b. Flexure two thin connecting segment 426b is connected to flexure two thick shorter segment 422d. Flexure two thick shorter segment 422d is connected to flexure two thin corner segment 428d. Flexure two thin corner segment 428d is connected to flexure two thick longer segment 424a.

In exemplary embodiments, flexure two thin connecting segments 426a and 426b include a thicker portion as well. That is, flexure two thin connecting segment 426a may include a first thin portion coupled to flexure two thick shorter segment 422a. Flexure two thick shorter segment 422a is further coupled to a thicker connecting portion, wherein the thicker connecting portion is further connected to a second thin portion which is connected to flexure two thick shorter segment 422b. Similarly, flexure two thin connecting segment 426b may include a third thin portion coupled to flexure two thick shorter segment 422.c Flexure two thick shorter segment 422c is further coupled to a thicker connecting portion, wherein the thicker connecting portion is further connected to a fourth thin portion which is connected to flexure two thick shorter segment 422d. Such a design makes second flexure section 420 more robust so that when pressure is applied to second flexure section 420, flexure two thin connecting segments 426a or 426b have capability of handling increased force.

As further shown in FIG. 4, first flexure section 410 may be nested within second flexure section 420 such that when an input force (such as force 432) is applied on second flexure section 420, flexure two thin connecting segment 426a couples with flexure one thick longer segment 412a and flexure two thin connecting segment 426b couples with flexure one thick longer segment 412b. In operation, when a force 432 is applied to second flexure section 420 on flexure two thick longer segment 424a in a direction along axis 452, a resultant force 434 is output in an inward direction along axis 454. Because flexure two thin connecting segment 426b and flexure one thick longer segment 412b are coupled, resultant force 434 on second flexure section 420 is an input force on flexure one thick longer segment 412b. The resultant force 436 is output along axis 452 in a direction opposite to force 432.

Referring back to FIG. 2, symmetric flexure assembly 400 is coupled to piston 204. As shown in FIG. 2, a top piston section 204-1 (functioning similar to a conventional piston) is coupled to flexure two thick longer segment 424a and a bottom piston section 204-2 (functioning similar to a conventional piston stem) is coupled to flexure one thin connecting segment 416b. Because of the operation of symmetric flexure assembly 400, when force 432 is applied downwards along axis 252 (which aligns with axis 452) on piston 204, a resultant force 436 is output in a direction opposition to force 432 keeping flexible diaphragm 208 in an open position. On the contrary, when force 432 is released, the resultant force 436 is in an opposite direction and pushes flexible diaphragm 208 to a closed position. Accordingly, in the exemplary embodiment shown in FIG. 4, flexible diaphragm 208 is naturally in a closed position to close valve channel 220. However, when input force 432 is applied on piston 204, flexible diaphragm 208 is pulled upwards to move it into open position and consequently open valve channel 220.

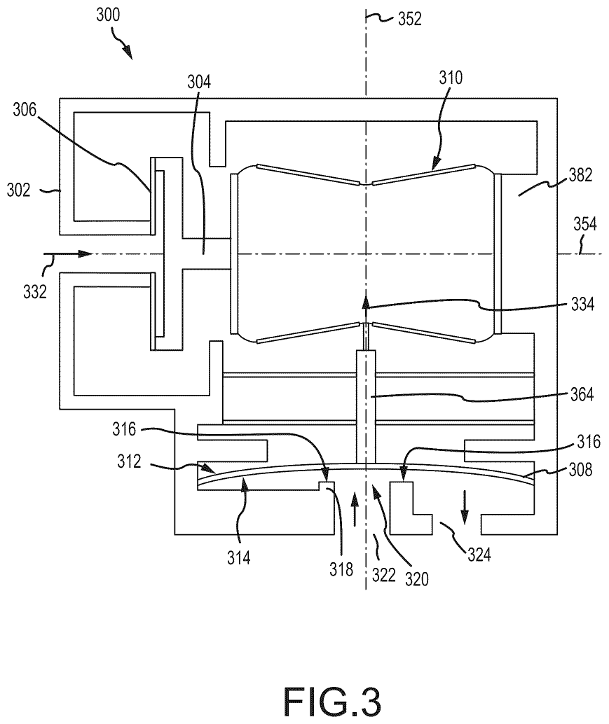

FIG. 3 illustrates a cross-sectional schematic diagram of another exemplary diaphragm valve 300 in accordance with the embodiments of the disclosure. In FIG. 3, diaphragm valve 300 is shown in open position, i.e., a valve channel 320 disposed between an inlet channel 322 (functioning similarly to inlet channel 122) and outlet channel 324 (functioning similarly to outlet channel 124) is unobstructed by a flexible diaphragm 308 (functioning similarly to flexible diaphragm 108), thereby allowing precursor to flow freely through the diaphragm valve 300.

Similar to diaphragm valve 100 of FIG. 1, a valve seat 318 may be disposed adjacent to the valve channel 320 and may surround the upper portion of the inlet channel 322. The valve seat 318 includes an upper surface 316 (functioning similarly to upper surface 116) that presents a sealing surface against which a wetted surface 314 of the flexible diaphragm 308 is pressed against in order to close the valve channel 320. The upper surface 316 of the valve seat 318 may be polished or otherwise made smooth to reduce contact resistance and to reduce leakage of precursor between the valve seat 318 and the flexible diaphragm 308 when the flexible diaphragm 308 is in the closed positioned.

The flexible diaphragm 308 may comprise a wetted surface 314 (functioning similarly to wetted surface 114 of FIG. 1), i.e., a surface which may come into direct contact with a precursor flowing through the diaphragm valve 300, and a non-wetted surface 312 (functioning similarly to non-wetted surface 112), i.e., a surface that may not come into direct contact with a precursor flowing through the diaphragm valve 300.

In exemplary embodiments, diaphragm valve 300 may be actuated using a blade flexure 306 (functioning similarly to blade flexure 106). In exemplary embodiments, diaphragm valve 300 may be actuated via a flexure assembly 310 (functioning similarly to actuator of FIG. 1) that may include a number of mechanisms including, but not limited to, pneumatic, hydraulic, and piezoelectric mechanisms. However, unlike diaphragm valves 100 and 200, flexure assembly 310 is coupled to valve body 302 of diaphragm valve 300 at a right angle. That is, instead of a force applied along axis 352 (which is aligned with axis 152, 252 and 452), an input force 332 is applied along axis 354 (which is aligned along axis 154, 254 and 454). Accordingly, another component may be accommodated in the spaced opened up. Diaphragm valve 300 further includes a first piston section 304 and a second piston section 364. Flexure assembly 310 is coupled to a first piston section 304 and a second piston section 364 is coupled to flexible diaphragm 308.

In exemplary embodiments, flexure assembly 310 may be a first flexure section 410 of symmetric flexure assembly 400 but does not include second flexure section 420. Thus, the functionality of flexure assembly 310 is described using first flexure section 410 as reference. As shown in FIG. 3, flexure assembly 310 is disposed along axis 352 (which may align with axis 452) and axis 354 (which may align with axis 454). Flexure one thick longer segment 412b may be coupled with the first piston section 304 and flexure one thin connecting segment 416b may be coupled to second piston section 364. Further, in exemplary embodiments, flexure one thick longer segment 412a may be anchored to a wall support 382. Accordingly, flexure assembly 310 remains centered at the intersection of axes 352 and 354.

Because of the operation of first flexure section 410, when an input force 332 is applied inward along axis 354 (which aligns with axis 454) on first piston section 304, first flexure section 410 flexes to result in an output force 334 in an upward direction along axis 352. Thus, force 334 results in the flexible diaphragm 308 being pushed up to an open position. On the contrary, when force 332 is released, the resultant output force 334 is in a downward direction, releasing flexible diaphragm 308 back to the closed position. Accordingly, in the exemplary embodiment shown in FIG. 3, flexible diaphragm 308 is naturally in a closed position to close valve channel 320. However, when force 332 is applied on first piston section 304, flexible diaphragm 308 is pulled upwards to move it into open position and consequently open valve channel 320.

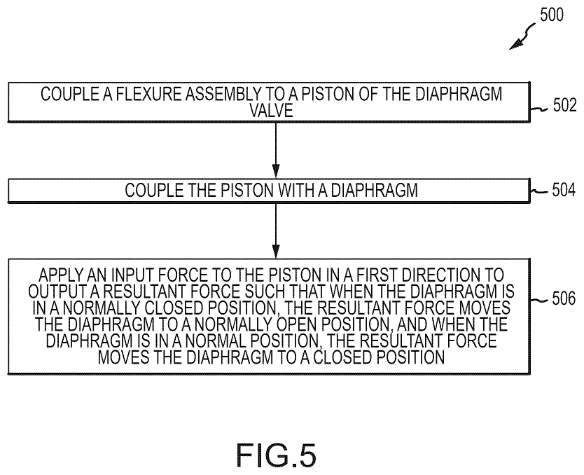

FIG. 5 illustrates a method 500 of operating a diaphragm valve, such as diaphragm valve 100. Method 500 includes coupling a flexure assembly (such as blade flexure 106, flexure assembly 310, or first flexure section 410) to a piston 104 or 20 or first piston section 304) of the diaphragm valve, as shown with box 502. In exemplary embodiments of method 500, the flexure assembly is a symmetric flexure assembly (such as flexure assembly 310 or symmetric flexure assembly 400) that couples to the piston and the diaphragm.

In exemplary embodiments of method 500, coupling a symmetric flexure assembly to the piston further includes coupling a first flexure section, such as 410, to the piston, coupling a second flexure section, such as 420, to the diaphragm. Method 500 may further include nesting the second flexure section within the first flexure section. Method 500 further includes coupling the piston with a diaphragm, as shown with box 504.

Method 500 also includes an input force to the piston in a first direction to output a resultant force such that when the diaphragm is in a normally closed position, the resultant force moves the diaphragm to an open position, and when the diaphragm is in a normally open position, the resultant force moves the diaphragm to a closed position, as shown with box 506. In exemplary embodiments of method 500, the resultant force is output in a second direction. In exemplary embodiments of method 500, the first direction and the second direction are perpendicular to each other. In exemplary embodiments of method 500, the first direction is opposite of the second direction.

The example embodiments of the disclosure described above do not limit the scope of the invention, since these embodiments are merely examples of the embodiments of the invention, which is defined by the appended claims and their legal equivalents. Any equivalent embodiments are intended to be within the scope of this invention. Indeed, various modifications of the disclosure, in addition to those shown and described herein, such as alternative useful combination of the elements described, may become apparent to those skilled in the art from the description. Such modifications and embodiments are also intended to fall within the scope of the appended claims.

What is claimed is:

1. A valve, comprising:
a valve body having a valve channel, the valve channel including an inlet channel and an outlet channel;
a valve seat adjacent to the valve channel;
a diaphragm movable to separate from or contact with the valve seat;
a piston coupled to the diaphragm; and
a flexure assembly coupled to the piston.

2. The valve of claim 1, wherein the flexure assembly further comprises:
a blade flexure that is coupled to the piston and the valve body such that when an input force is applied on the piston, the diaphragm moves to contact the valve seat.

3. The valve of claim 2, wherein the blade flexure is configured to actuate the valve by increasing internal pressure of the valve.

4. The valve of claim 1, wherein the flexure assembly further comprises:
a symmetric flexure assembly coupled to the piston, the symmetric flexure assembly further coupled to the diaphragm wherein when an input force is applied on the piston in a first direction a resultant force is output in a second direction such that when the diaphragm is in a normally close position, the diaphragm moves to separate from the valve seat, and wherein the diaphragm is in a normally open position, the diaphragm moves to contact the valve seat.

5. The valve of claim 4, wherein the first direction and the second direction are perpendicular.

6. The valve of claim 5, wherein the symmetric flexure assembly includes a first flexure section, wherein the first flexure section further comprises:
a first flexure one thick longer segment and a second flexure one thick longer segment;
a first flexure one thick shorter segment, a second flexure one thick shorter segment, a third flexure one thick shorter segment and a fourth flexure one thick shorter segment;
a first flexure one thin corner segment, a second flexure one thin corner segment, a third flexure one thin corner segment and a fourth flexure one thin corner segment; and
a first flexure one thin connecting segment and a second flexure one thin connecting segment;
wherein the first flexure one thick longer segment is coupled to the first flexure one thin corner segment, the first flexure one thin corner segment is coupled to the first flexure one thick shorter segment, the first flexure one thick shorter segment is coupled to the first flexure one thin connecting segment, the first flexure one thin connecting segment is coupled to the second flexure one thick shorter segment, the second flexure one thick shorter segment is coupled to the second flexure one thin corner segment, the second flexure one thin corner segment is coupled to the second flexure one thick longer segment, the second flexure one thick longer segment is coupled to the third flexure one thin corner segment, the third flexure one thin corner segment is coupled to the third flexure one thick shorter segment, the third flexure one thick shorter segment is coupled to the second flexure one thin connecting segment, the second flexure one thin connecting segment is coupled to the fourth flexure one thick shorter segment, the fourth flexure one thick shorter segment is coupled to the fourth flexure one thin corner segment, and the fourth flexure one thin corner segment is coupled back to the first flexure one thick longer segment.

7. The valve of claim 4, wherein the first direction is opposite of the second direction.

8. The valve of claim 4, wherein the symmetric flexure assembly comprises a first flexure section and a second flexure section, wherein the first flexure section is nested within the second flexure section such that the first flexure section is coupled to the diaphragm and the second flexure section is coupled to the piston, and wherein when the input force is applied to the piston in the first direction, the resultant force is output in the second direction to separate the diaphragm from contact with the valve seat.

9. The valve of claim 7, wherein the first direction is opposite of the second direction.

10. The valve of claim 7, comprising a second flexure section further having:
a first flexure two thick longer segment and a second flexure two thick longer segment;
a first flexure two thick shorter segment, a second flexure two thick shorter segment, a third flexure two thick shorter segment and a fourth flexure two thick shorter segment;
a first flexure two thin corner segment, a second flexure two thin corner segment, a third flexure two thin corner segment and a fourth flexure two thin corner segment; and
a first flexure two thin connecting segment and a second flexure two thin connecting segment;
wherein the first flexure two thick longer segment is coupled to the first flexure two thin corner segment, the first flexure two thin corner segment is coupled to the first flexure two thick shorter segment, the first flexure two thick shorter segment is coupled to the first flexure two thin connecting segment, the first flexure two thin connecting segment is coupled to the second flexure two thick shorter segment, the second flexure two thick shorter segment is coupled to the second flexure two thin corner segment, the second flexure two thin corner segment is coupled to the second flexure two thick longer segment, the second flexure two thick longer segment is coupled to the third flexure two thin corner segment, the third flexure two thin corner segment is coupled to the third flexure two thick shorter segment, the third flexure two thick shorter segment is coupled to the second flexure two thin connecting segment, the second flexure two thin connecting segment is coupled to the fourth flexure two thick shorter segment, the fourth flexure two thick shorter segment is coupled to the fourth flexure two thin corner segment, and the fourth flexure two thin corner segment is coupled back to the first flexure two thick longer segment.

11. The valve of claim 1, wherein the valve is a diaphragm valve.

12. The valve of claim 1, wherein the flexure assembly is an annular flexure.

13. A method of operating a diaphragm valve comprising:
coupling a flexure assembly to a piston of the diaphragm valve;
coupling the piston with a diaphragm; and
applying an input force to the piston in a first direction to output a resultant force such that when the diaphragm is in a normally closed position, the resultant force moves the diaphragm to an open position, and when the diaphragm is in a normally open position, the resultant force moves the diaphragm to a closed position.

14. The method of claim 13, wherein the resultant force is output in a second direction.

15. The method of claim 14, wherein the first direction and the second direction are perpendicular to each other.

16. The method of claim 14, wherein the first direction is opposite of the second direction.

17. The method of claim 13, wherein coupling the flexure assembly to the piston further comprises:
coupling a symmetric flexure assembly to the piston;
coupling the symmetric flexure assembly to the diaphragm; and
applying the input force to the piston in the first direction.

18. The method of claim 16,
wherein coupling a symmetric flexure assembly to the piston comprises coupling a first flexure section to the piston;
wherein coupling the symmetric flexure assembly to the diaphragm comprises coupling a second flexure section to the diaphragm; and
wherein the second flexure section is nested within the first flexure section.

19. The method of claim 13, wherein coupling the flexure assembly to the piston further comprises coupling a blade flexure to the piston.

20. An actuator comprising:
a diaphragm movable to separate from or contact with a valve seat;
a piston coupled to the diaphragm; and
a flexure assembly coupled to the piston.
